(19) United States
(12) Patent Application Publication
(10) Pub. No.: US 2025/0023131 A1
(43) Pub. Date: Jan. 16, 2025

(54) BATTERY PACK AND VEHICLE

(71) Applicant: Toyota Jidosha Kabushiki Kaisha, Toyota-shi (JP)

(72) Inventors: Keisuke UKITA, Toyoake-shi (JP); Yusuke Kuruma, Toyota-shi (JP); Tsubasa Migita, Osaka (JP); Kei Morikawa, Toyota-shi (JP); Yasumasa Oguma, Nagoya-shi (JP)

(73) Assignee: Toyota Jidosha Kabushiki Kaisha, Toyota-shi (JP)

(21) Appl. No.: 18/443,745

(22) Filed: Feb. 16, 2024

(30) Foreign Application Priority Data
Jul. 12, 2023 (JP) 2023-114498

(51) Int. Cl. H01M 10/52; H01M 10/0562; H01M 10/48

(52) U.S. Cl. CPC H01M 10/52; H01M 10/0562; H01M 10/482; H01M 10/488; H01M 2220/20

(57) ABSTRACT

The unit cell is composed of a sulfide-based all-solid-state battery. The battery pack includes a battery module in which a plurality of unit cells is stacked between a pair of end plates. The battery module is housed in a battery case. A duct is attached to the opening formed in the ceiling surface of the upper case. A desulfurization agent is disposed inside the duct, and is configured as a desulfurization unit. A hydrogen sulfide sensor is disposed inside the duct. By detecting the hydrogen sulfide by the hydrogen sulfide sensor, it is possible to sense that the adsorption amount of the hydrogen sulfide of the desulfurization agent is saturated or that there is a possibility of saturation.

### CROSS-REFERENCE TO RELATED APPLICATION

This application claims priority to Japanese Patent Application No. 2023-114498 filed on Jul. 12, 2023, incorporated herein by reference in its entirety.

### BACKGROUND

### 1. Technical Field

The present disclosure relates to a battery pack and a vehicle.

### 2. Description of Related Art

Japanese Unexamined Patent Application Publication No. 2011-113803 (JP 2011-113803 A) discloses a solid-state battery in which a sulfur-based material is used for at least one of an anode, a cathode, and a solid electrolyte. Further disclosed regarding this solid-state battery is that a hydrogen sulfide detoxifying agent is provided in a recessed portion provided in a battery case (housing).

JP 2011-113803 A contains a description that hydrogen sulfide generated from an all-solid-state battery is absorbed by the hydrogen sulfide detoxifying agent and detoxified.

### SUMMARY

There is a limit to an absorption amount (adsorption amount) of hydrogen sulfide by the hydrogen sulfide detoxifying agent. Accordingly, sensing of saturation of the hydrogen sulfide adsorption amount in the hydrogen sulfide detoxifying agent, or that saturation thereof is likely, is desirable. However, JP 2011-113803 A makes no mention of this point.

An object of the present disclosure is to enable sensing of saturation of the hydrogen sulfide adsorption amount in a desulfurization agent that adsorbs (absorbs) hydrogen sulfide, or that saturation thereof is likely.

1

A battery pack according to the present disclosure includes
a battery, made up of a sulfide-based all-solid-state battery housed in a battery case,
a communication passage communicating between an inside and an outside of the battery case,
a desulfurization agent for adsorbing hydrogen sulfide, provided in the communication passage, and
a hydrogen sulfide sensor for detecting hydrogen sulfide, provided in the communication passage.

According to this configuration, the battery is made up of a sulfide-based all-solid-state battery. In the present disclosure, the sulfide-based all-solid-state battery contains a sulfur component in at least one of material of an anode and material of a solid electrolyte material. When the sulfur component contained in the sulfide-based all-solid-state battery reacts with moisture, hydrogen sulfide is generated. When air containing the hydrogen sulfide within the battery case is discharged to the outside via the communication passage, the hydrogen sulfide is removed (adsorbed) by the desulfurization agent. Accordingly, hydrogen sulfide can be suppressed from being discharged to the outside of the battery case.

The hydrogen sulfide sensor is provided in the communication passage. Based on the hydrogen sulfide within the communication passage that is detected by the hydrogen sulfide sensor, saturation of the hydrogen sulfide adsorption amount in the desulfurization agent, or that saturation thereof is likely, can be sensed.

2

The hydrogen sulfide sensor may be provided toward the outside side of the battery case from the desulfurization agent in the communication passage.

According to this configuration, the hydrogen sulfide sensor is provided toward the outside side of the battery case from the desulfurization agent in the communication passage. Accordingly, when there is a likelihood of saturation of the hydrogen sulfide adsorption amount in the desulfurization agent, hydrogen sulfide is detected by the hydrogen sulfide sensor.

3

The communication passage may include a narrow passage portion of which a channel cross-sectional area is smaller than that of other portions, and the hydrogen sulfide sensor may be provided in the narrow passage portion.

Hydrogen sulfide is heavier than air (has a specific gravity greater than that of air), and tends to stay on a bottom face (downward in a vertical direction) side of the communication passage. Accordingly, concentration thereof may vary within the communication passage. According to this configuration, in the narrow passage portion in which the channel cross-sectional area is smaller than that of other portions, there it is highly likely that variance in the concentration of the hydrogen sulfide will be small. Accordingly, hydrogen sulfide can be detected more reliably.

4

The communication passage may include
a first desulfurization unit including the desulfurization agent,
a second desulfurization unit including the desulfurization agent, and
and a connecting pipe connecting the first desulfurization unit and the second desulfurization unit.

The first desulfurization unit may be disposed toward the outside side of the battery case from the second desulfurization unit.

Air containing hydrogen sulfide in the battery case passes through the second desulfurization unit, and thereafter flows into the first desulfurization unit. According to this configuration, the hydrogen sulfide adsorption amount of the second desulfurization unit becomes saturated first. Accordingly, just the second desulfurization unit can be replaced as necessary.

5

A vehicle according to the present disclosure includes
the battery pack according to 1 to 4 above, and
a control device.

The control device is configured to perform notification when a detection value of the hydrogen sulfide sensor satisfies a predetermined condition.

According to this configuration, for example, when the detection value of the hydrogen sulfide sensor satisfies a condition that the hydrogen sulfide adsorption amount of the desulfurization agent is saturated or satisfies a condition that saturation is highly likely, notification can be performed, and replacement of the desulfurization agent can be prompted.

According to the present disclosure, sensing of saturation of the hydrogen sulfide adsorption amount in the desulfurization agent that adsorbs (absorbs) hydrogen sulfide, or that saturation is likely, can be enabled.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of a vehicle equipped with a battery pack according to the present embodiment;

FIG. 2 is a schematic configuration diagram of a battery pack;

FIG. 3A is a diagram illustrating a schematic configuration of a unit cell;

FIG. 3B is a diagram illustrating a schematic configuration of a unit cell;

FIG. 4 is a diagram illustrating functional blocks configured in an ECU;

FIG. 5A is a diagram illustrating a desulfurization unit Dsu according to a modification;

FIG. 5B is a diagram illustrating a desulfurization unit Dsu according to a modification;

and

FIG. 6 is a diagram for explaining the desulfurization unit Dsu in of the second embodiments.

### DETAILED DESCRIPTION OF EMBODIMENTS

Hereinafter, embodiments of the present disclosure will be described in detail with reference to the drawings. In the drawings, the same or corresponding parts are denoted by the same reference numerals. The description will not be repeated.

### First Embodiment

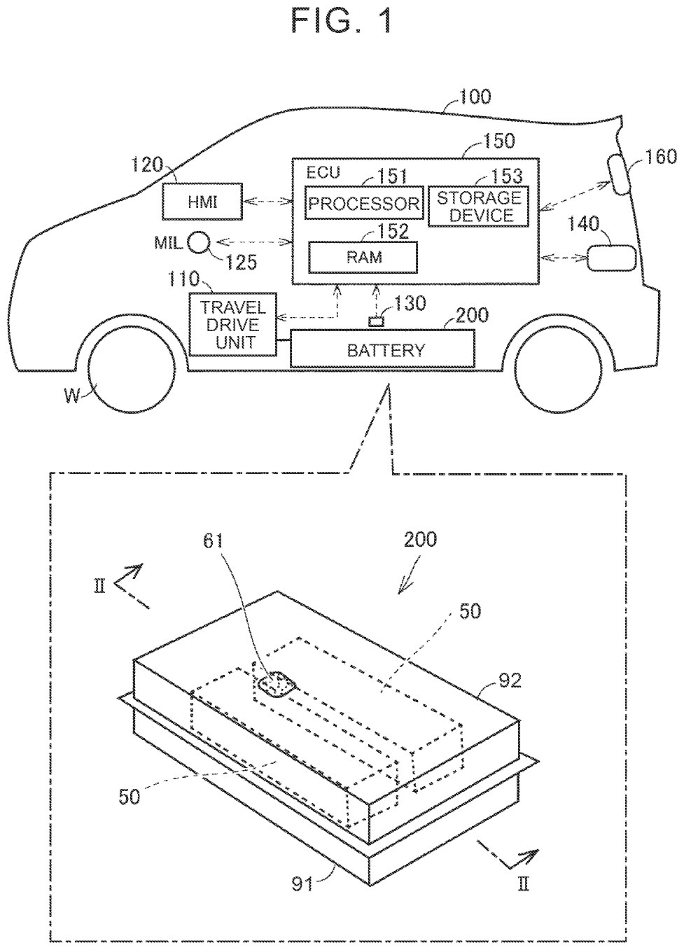

FIG. 1 is a diagram schematically showing an overall configuration of a vehicle 100 equipped with a battery pack 200 according to the present embodiment. The vehicle 100 includes a battery pack 200 that stores electric power for traveling. The vehicle 100 is configured to be able to travel using the electric power stored in the battery pack 200. In the present embodiment, the vehicle 100 is a battery electric vehicle (BEV) that does not include an engines (internal combustion engine). However, the vehicle 100 may be engine-equipped hybrid electric vehicle (HEV) or plug-in hybrid electric vehicle (PHEV).

Vehicle 100 includes a control device (Electronic Control Unit (ECU)) 150. ECU 150 is configured to perform charge-control and discharge-control of the battery pack 200. ECU 150 includes a processor 151, a Random Access Memory (RAM) 152, and a storage device 153. RAM 152 functions as working memories for temporarily storing data to be processed by the processor 151. In addition to the program, information (for example, a map, a mathematical expression, and various parameters) used in the program is stored in the storage device 153. The processor 151 executes programs stored in the storage device 153 to perform various types of control in ECU 150.

The monitoring module 130 includes various sensors that detect the state (e.g., voltage, current, and temperature) of the battery pack 200 (the battery module 50). Then, the monitoring module 130 outputs the detection result to ECU 150. The battery pack 200 is charged (externally charged) by electric power supplied from a charging facility.

The vehicle 100 further includes a travel drive unit 110, a Human Machine Interface (HMI) device 120, a Malfunction Indicator Lamp (MIL) 125, a hazard lamp 140, an external display 160, and drive wheels W. The travel drive unit 110 includes a Power Control Unit (PCU) (not shown) and a Motor Generator (MG) (not shown). The travel drive unit 110 is configured to drive MG by using the electric power stored in the battery pack 200 to cause the vehicle 100 to travel. In addition, MG is configured to perform regenerative power generation and provide the generated electric power to the battery pack 200.

HMI device 120 includes an inputting device and a displaying device. HMI device 120 may include a touch panel display. MIL 125 is a warning light arranged on the instrument panel. The hazard lamp 140 is a lamp disposed on the front, rear, left, and right sides of the vehicle 100. The hazard lamp 140 is the same lamp as the winker (direction indicator). The hazard lamp 140 functions as an emergency blinking indicator lamp. The external display 160 is, for example, a LED indicator. The external display 160 is provided in the rear window. Then, the external display 160 is capable of visually recognizing the display contents from the outside of the vehicle 100.

The battery pack 200 includes a battery case 90 and a battery module 50 stored in the battery case 90. The battery case 90 includes a lower case 91 and an upper case 92. In the present embodiment, two battery modules 50 are stored in a space formed by the lower case 91 and the upper case 92. The upper case 92 is provided with a respiratory membrane 61. The respiratory membrane 61 will be described later. The battery pack 200 may be mounted on the floor of the vehicle 100, may be mounted on the inside of the vehicle cabin of the vehicle 100, or may be mounted on the outside of the vehicle cabin of the vehicle 100.

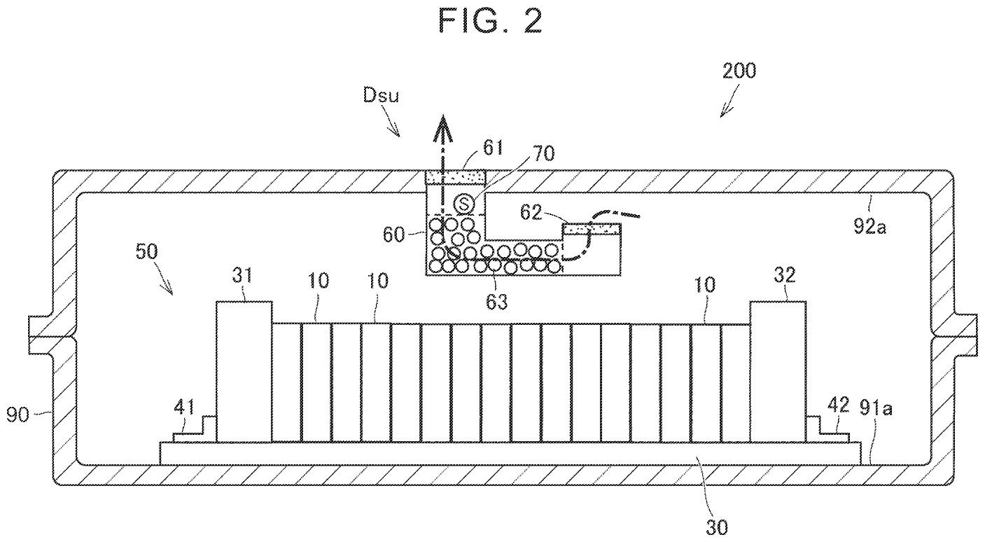

FIG. 2 is a diagram illustrating a schematic configuration of the battery pack 200. FIG. 2 is a II-II cross section in FIG. 1. The battery module 50 is an assembled battery in which a plurality of unit cells 10 are connected. The unit cells 10 are stacked between a pair of end plates 31 and 32.

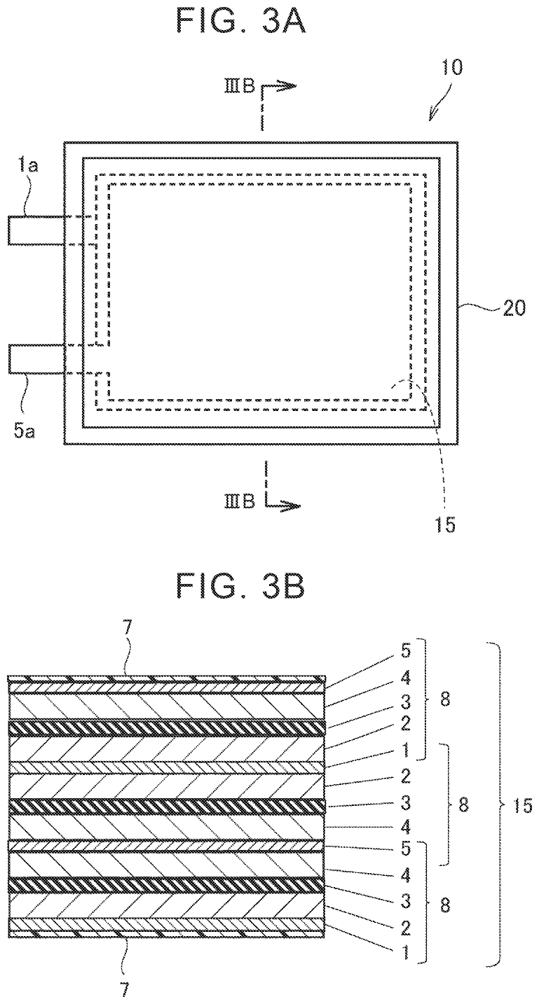

FIGS. 3A and 3B are diagrams for explaining a schematic configuration of the unit cell 10 according to the present embodiment. FIG. 3A is a top view of a unit cell 10. The unit cell 10 is a laminated all-solid-state battery using a laminate film as an exterior member 20. A cathode terminal (cathode tab) 1a and an anode terminal (anode tab) 5a protrude from the exterior member 20. The laminate film may be, for example, a pouch made of aluminum laminate fill. The laminate film may be, for example, a film having a three-layer structure in which an aluminum foil is sandwiched between resin films.

FIG. 3B is an all-solid-state battery stack 15 housed in the exterior member 20, and shows a IIIB-IIIB cross-section of FIG. 3A. In the all-solid-state battery stack 15, the all-solid-state battery elements 8 share the cathode current collector layer 1 and the anode current collector layer 5, and three of them are stacked in the reverse direction in the stacking order. In the all-solid-state battery element 8, the cathode current collector layer 1, the cathode active material layer 2, the solid electrolyte layer 3, the anode active material layer 4, and the anode current collector layer 5 are stacked in this order. The cathode current collector layer 1 is connected to the cathode terminal 1a. The anode current collector layer 5 is connected to the anode terminal 5a. Note that, the number of all-solid-state battery elements 8 included in the all-solid-state battery stack 15 may be one, or may be four or more. An insulating film 7 provides insulation between the all-solid-state battery stack 15 and the exterior member (laminate film) 20.

The unit cell 10 is a sulfide-based all-solid-state battery. In the present disclosure, a sulfide-based all-solid-state battery contains a sulfur component in at least one of the material of the anode active material layer 4 and the material of the solid electrolyte layer 3. In the present embodiment, the solid electrolyte layer 3 contains a sulfide-based solid electrolyte. For example, the sulfide-based solid electrolyte may use phosphorus pentasulfide (P₂S₅) and lithium sulfide (Li₂S) as starting materials. In this case, the anode active material layer 4 may contain, for example, lithium cobalt oxide, lithium nickel oxide, lithium iron phosphate, and the like. When the solid electrolyte layer 3 consists of an oxide-based solid electrolyte, the anode active material layer 4 is made of a sulfur-based anode active material. The sulfur-based anode active material may be an organic sulfur compound or an inorganic sulfur compound. Note that both the solid electrolyte layer 3 and the anode active material layer 4 may contain the sulfur component.

In the unit cell 10, for example, there is a concern that air enters from a sealing portion of the exterior member 20 (laminate film). When moisture is contained in the entering air, there is a possibility that moisture reacts with the sulfur component contained in the solid electrolyte layer 3 or the anode active material layer 4. Then, hydrogen sulfide may be generated and discharged into the battery case 90.

Referring to FIG. 2, a plurality of unit cells 10 are disposed between a pair of end plates 31 and 32 and stacked. The plurality of unit cells 10 are sandwiched between a pair of end plates 31 and 32 in a stacked state. In the plurality of unit cells 10, a predetermined restraining load is applied by a restraining band or the like (not shown). The pair of end plates 31 and 32 are fixed to the bottom plate 30 by brackets 41 and 42. The battery module 50 including the unit cell 10, the bottom plate 30, and the like stacked between the pair of end plates 31 and 32 is fixed to the bottom surface 91a of the lower case 91. The battery case 90 is a housing that houses the battery module 50.

The upper case 92 is provided with a duct 60. The duct 60 is a communication passage that communicates the inside and the outside of the battery case 90. When the internal pressure of the battery case 90 increases, the duct 60 discharges the air in the battery case 90 to the outside. When the internal pressure of the battery case 90 becomes low, the duct 60 takes in outside air. The duct 60 is attached to an opening formed in the ceiling-surface 92a of the upper case 92.

At an end portion of the duct 60, respiratory membranes 61 and 62 are provided, which are formed of an air permeable waterproof (moisture permeable waterproof) sheet. The air-permeable waterproof (moisture-permeable waterproof) sheet may be, for example, GORE-TEX. A desulfurization agent 63 is disposed inside the duct 60. The desulfurization agent 63 may be, for example, a pelletized desulfurization agent containing iron oxide as a main component. The desulfurization agent 63 chemically adsorbs hydrogen sulfide. Any desulfurization agent may be used as long as it adsorbs and absorbs the desulfurization agent 63. When the internal pressure of the battery case 90 increases, the air in the battery case 90 is discharged to the outside through the duct 60 as indicated by the arrow indicated by the dashed line. At this time, the hydrogen sulfide contained in the air is chemically adsorbed by the desulfurization agent 63, and the hydrogen sulfide is purified. In this way, the duct 60 and the desulfurization agent 63 are configured as a desulfurization unit Dsu.

A hydrogen sulfide sensor 70 is disposed inside the duct 60. The hydrogen sulfide sensor 70 is a sensor that detects the level of hydrogen sulfide (H₂S) contained in the atmosphere. The hydrogen sulfide sensor 70 outputs a signal indicating the detection result to ECU 150. The hydrogen sulfide sensor 70 may be, for example, a hot wire type semiconductor type sensor or a constant potential electrolytic type sensor. In the present embodiment, the hydrogen sulfide sensor 70 is disposed on the outside side of the battery case 90 (the downstream side of the flow when the hydrogen sulfide contained in the air in the battery case 90 is discharged) from the desulfurization agent 63 in the duct 60.

When the air containing hydrogen sulfide in the battery case 90 is discharged to the outside of the battery case 90 via the duct 60, the hydrogen sulfide is purified (adsorbed) by the desulfurization agent 63, and the hydrogen sulfide can be suppressed from being discharged to the outside of the battery case 90. When the adsorption amount of hydrogen sulfide adsorbed by the desulfurization agent 63 is saturated, it becomes difficult to adsorb hydrogen sulfide by the desulfurization agent 63. Then, hydrogen sulfide flows from the desulfurization agent 63 to the outside side of the battery case 90 (the downstream side of the flow when the hydrogen sulfide is discharged). When the hydrogen sulfide adsorption amount of the desulfurization agent 63 approaches the saturated state, the adsorption capacity of the hydrogen sulfide of the desulfurization agent 63 becomes low, and hydrogen sulfide may flow from the desulfurization agent 63 to the outside side of the battery case 90. According to the present embodiment, hydrogen sulfide is detected by the hydrogen sulfide sensor 70 disposed in the duct 60 on the outside side of the battery case 90 from the desulfurization agent 63. As a result, it is possible to sense that the adsorption amount of hydrogen sulfide of the desulfurization agent 63 is saturated or that the desulfurization agent may be saturated.

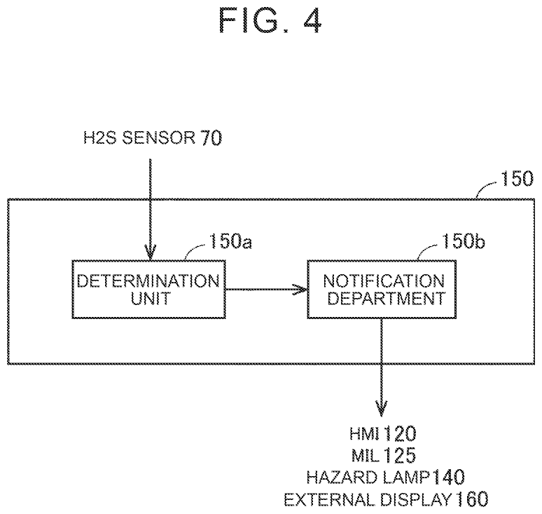

FIG. 4 is a diagram illustrating functional blocks configured in an ECU 150. The determination unit 150a determines whether or not the predetermined condition is satisfied based on the detection signal (detection value) of the hydrogen sulfide sensor 70. When the determination unit 150a determines that the predetermined condition is satisfied, the notification unit 150b performs notification using at least one of HMI device 120, MIL 125, the hazard lamp 140, and the external display 160. In the present embodiment, in the determination unit 150a, when hydrogen sulfide is detected by the hydrogen sulfide sensor 70, the notification unit 150b displays “the desulfurization unit needs to be replaced” on the display device of HMI device 120. At the same time, the notification unit 150b turns on MIL 125. Accordingly, the user of the vehicle 100 can be notified that the desulfurization unit Dsu needs to be replaced. Note that “when hydrogen sulfide is detected by the hydrogen sulfide sensor 70” may be a case where the concentration of hydrogen sulfide becomes a concentration detectable by the hydrogen sulfide sensor 70 (concentration at the detection lower limit).

When the determination unit 150a determines that the detected value (the concentration of hydrogen sulfide) of the hydrogen sulfide sensor 70 exceeds the set value, the notification unit 150b turns on MIL 125. Then, the notification unit 150b displays a message requesting the display device of HMI device 120 to “replace the desulfurization unit” and “stop to the road shoulder/limp home”. Then, the notification unit 150b causes the hazard lamp 140 to blink, and also displays a message indicating “caution (hydrogen sulfide)” on the external display.

According to the present embodiment, by detecting hydrogen sulfide by the hydrogen sulfide sensor 70 disposed in the duct 60 on the outside side of the battery case 90 from the desulfurization agent 63, it is possible to sense that the adsorption amount of hydrogen sulfide of the desulfurization agent 63 is saturated. Then, it is possible to prompt the user to replace the desulfurization agent 63 (desulfurization unit Dsu). Further, when a large amount of hydrogen sulfide is generated, it is also possible to alert the surroundings of the vehicle 100.

### Modifications

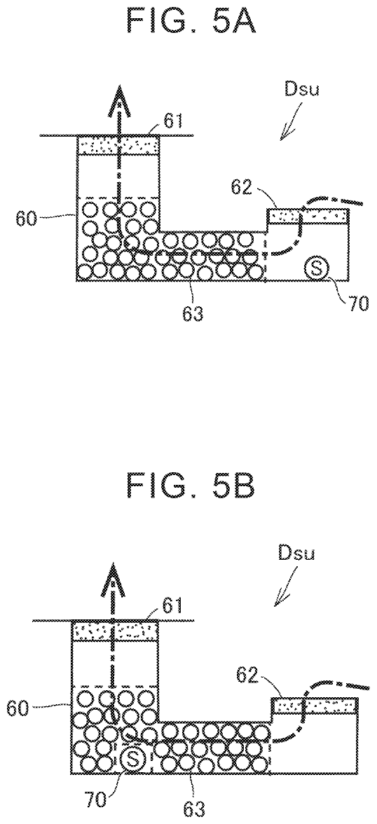

FIGS. 5A and 5B are diagrams illustrating a desulfurization unit Dsu according to a modification. In the desulfurization unit Dsu shown in FIG. 5A, the hydrogen sulfide sensor 70 is disposed on the inside side of the battery case 90 (the upstream side of the flow when the hydrogen sulfide contained in the air in the battery case 90 is discharged) from the desulfurization agent 63 in the duct 60. The determination unit 150a integrates Chs [ppm] of hydrogen sulfide detected by the hydrogen sulfide sensor 70 per unit time (for example, 1 second). When the integrated value exceeds the predetermined value A, the determination unit 150a determines that the predetermined condition is satisfied. Then, the notification unit 150b displays [need to replace the desulfurization unit] on the display device of HMI device 120 and turns on MIL 125. The predetermined value A is set on the basis of the amount of ventilation inside the battery case 90, the amount of saturation of hydrogen sulfide adsorption of the desulfurization agent 63, and the like by an experiment or the like in advance.

In the desulfurization unit Dsu shown in FIG. 5B of the drawing, the hydrogen sulfide sensor 70 is provided in a part of the duct 60 where the desulfurization agent 63 is disposed. The determination unit 150a integrates Chs [ppm] of hydrogen sulfide detected by the hydrogen sulfide sensor 70 per unit time (for example, 1 second). When the integrated value exceeds the predetermined value B, the determination unit 150a determines that the predetermined condition is satisfied. Then, the notification unit 150b displays [need to replace the desulfurization unit] on the display device of HMI device 120 and turns on MIL 125. The predetermined value B is set in advance by an experiment or the like. The predetermined value B is set to a value smaller than the predetermined value A.

In these modifications, when the integrated value exceeds the predetermined value A or the predetermined value B, and then the detected value (the concentration of hydrogen sulfide) of the hydrogen sulfide sensor 70 continuously exceeds the set value, the notification unit 150b further displays a message indicating that the display device of HMI device 120 is required to “stop to the road shoulder/limp home”. Then, the notification unit 150b may blink the hazard lamp 140 and display a message indicating “caution (hydrogen sulfide)” on the external display.

### Embodiment 2

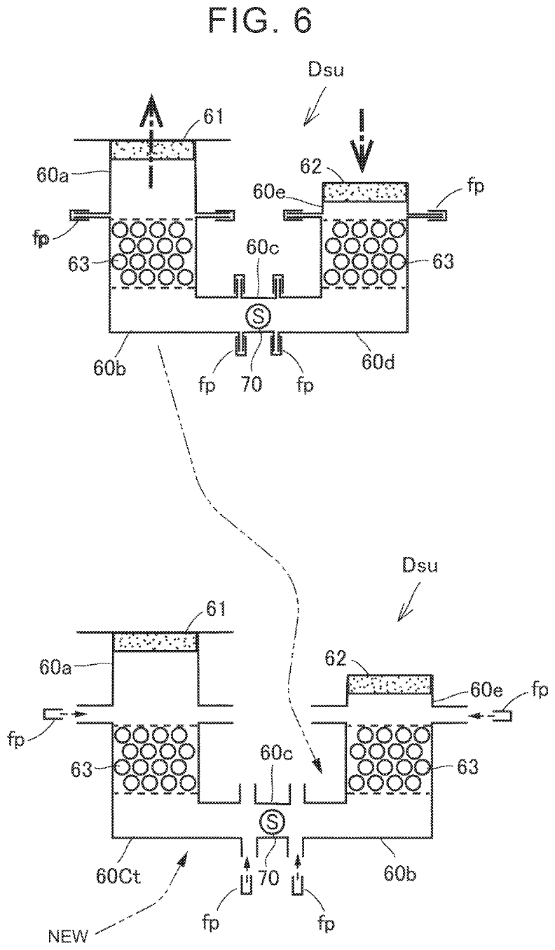

FIG. 6 is a diagram for explaining the desulfurization unit Dsu in the second embodiment. Embodiment 2 is the same as Embodiment 1 except for the configuration of the desulfurization unit Dsu. The desulfurization unit Dsu of the second embodiment is composed of five ducts 60a and 60e as shown in the upper part of FIG. 6. The first duct 60a comprises a respiratory membrane 61. The first duct 60a is attached to the opening of the battery case 90 (upper case 92). A desulfurization agent 63 is disposed inside the second duct 60b and the fourth duct 60d. The third duct 60c connects the second duct 60b and the fourth duct 60d. The fifth duct 60e includes a respiratory membrane 62 and communicates with the inside of the battery case 90 via the respiratory membrane 62.

The first duct 60a and the second duct 60b are fastened to each other by a fastening member fp. The fastening member fp may be, for example, a clipping or a threaded fastening member. The second duct 60b and the third duct 60c are fastened to each other by a fastening member fp. The third duct 60c and the fourth duct 60d are fastened to each other by a fastening member fp. The fourth duct 60d and the fifth duct 60e are fastened to each other by a fastening member fp.

The second duct 60b and the fourth duct 60d in which the desulfurization agent 63 is disposed have substantially the same configuration. The second duct 60b and the fourth duct 60d have the function of a replaceable desulfurization unit 60Ct. The third duct 60c connects the second duct 60b (desulfurization unit 60Ct) and the fourth duct 60d (desulfurization unit 60Ct). The third duct 60c corresponds to an exemplary “connecting pipe” of the present disclosure. The second duct 60b (desulfurization unit 60Ct) corresponds to the “first desulfurization unit”. The fourth duct 60d (desulfurization unit 60Ct) corresponds to the “second desulfurization unit” of the present disclosure. The second duct 60b is disposed on the outside side of the battery case 90 (the downstream side of the flow when the hydrogen sulfide contained in the air in the battery case 90 is discharged) from the fourth duct 60d.

The channel cross-sectional area of the third duct 60c is smaller than the channel cross-sectional area of the other ducts (the first duct 60a, the second duct 60b, the fourth duct 60d, and the fifth duct 60c). The third duct 60c corresponds to an exemplary “narrow passage portion” of the present disclosure. A hydrogen sulfide sensor 70 is provided inside the third duct 60c.

In the second embodiment, when hydrogen sulfide is detected by the hydrogen sulfide sensor 70 in the determination unit 150a of ECU 150, the notification unit 150b displays “need to replace the desulfurization unit” on the display device of HMI device 120 and turns on MIL 125. When hydrogen sulfide is detected by the hydrogen sulfide sensor 70, it is highly likely that the adsorption amount of hydrogen sulfide adsorption of the fourth duct 60d (desulfurization unit 60Ct) is saturated. Thus, the user can be notified that the fourth duct 60d (desulfurization unit 60Ct) needs to be replaced. Then, replacement of the fourth duct 60d (desulfurization unit 60Ct) can be urged.

When the adsorption amount of hydrogen sulfide adsorption of the fourth duct 60d (desulfurization unit 60Ct) is saturated and replacement is performed, as shown in the lower part of FIG. 6, the second duct 60b (desulfurization unit 60Ct) used up to now is connected to the fifth duct 60e. The new desulfurization unit 60Ct may be connected to the first duct 60a. This is because, when hydrogen sulfide is detected by the hydrogen sulfide sensor 70, the adsorption amount of hydrogen sulfide adsorption of the second duct 60b (desulfurization unit 60Ct) has enough margin until saturated.

When the hydrogen sulfide adsorption amount of the fourth duct 60d (desulfurization unit 60Ct) is saturated, the hydrogen sulfide flows through the third duct 60c to the second duct 60b (desulfurization unit 60Ct). At this time, when the hydrogen sulfide flowing through the third duct 60c is less than or equal to the detection limit of the hydrogen sulfide sensor 70, the hydrogen sulfide cannot be detected by the hydrogen sulfide sensor 70. Even in such cases, hydrogen sulfide is adsorbed by the desulfurization agent 63 on the second duct 60b. Therefore, it is possible to prevent hydrogen sulfide from being discharged to the outside of the battery case 90.

In the second embodiment, the hydrogen sulfide sensor 70 is provided in the third duct 60c in which the channel cross-sectional area is smaller than the channel cross-sectional area of another duct. Hydrogen sulfide is heavier than air (more specific gravity than air). Within the duct, the concentration may vary. In the third duct 60c having a small channel cross-sectional area, there is a high possibility that variations in the density of hydrogen sulfide in the duct become small. Therefore, it is possible to more reliably detect hydrogen sulfide.

In the above embodiment, an example in which the battery pack 200 is mounted on the vehicle 100 has been described. The battery pack 200 may be a stationary power storage device.

The embodiment disclosed herein should be considered as illustrative and not restrictive in all respects. The scope of the disclosure is indicated by the appended claims rather than by the foregoing description of the embodiments. The scope of the present disclosure is intended to include all modifications within the meaning and range equivalent to the scope of the claims.

What is claimed is:

1. A battery pack comprising:
a battery, made up of a sulfide-based all-solid-state battery housed in a battery case;
a communication passage communicating between an inside and an outside of the battery case;
a desulfurization agent for adsorbing hydrogen sulfide, provided in the communication passage; and
a hydrogen sulfide sensor for detecting hydrogen sulfide, provided in the communication passage.

2. The battery pack according to claim 1, wherein the hydrogen sulfide sensor is provided on the outside side of the desulfurization agent in the communication passage.

3. The battery pack according to claim 1, wherein:
the communication passage includes a narrow passage portion of which a channel cross-sectional area is smaller than that of other portions; and
the hydrogen sulfide sensor is provided in the narrow passage portion.

4. The battery pack according to claim 1, wherein:
the communication passage includes
a first desulfurization unit including the desulfurization agent,
a second desulfurization unit including the desulfurization agent, and
a connecting pipe connecting the first desulfurization unit and the second desulfurization unit; and
the first desulfurization unit is disposed on the outside side of the second desulfurization unit.

5. A vehicle comprising:
the battery pack according to claim 1; and
a control device, wherein the control device is configured to perform notification when a detection value of the hydrogen sulfide sensor satisfies a predetermined condition.
